(19) United States
(12) Patent Application Publication
(10) Pub. No.: US 2022/0172279 A1
(43) Pub. Date: Jun. 2, 2022

(54) A CONSTRUCTION EQUIPMENT RENTAL SYSTEM AND METHOD

(71) Applicant: Hiremate Limited, Dublin 2 (IE)

(72) Inventors: Jarlath O'Leary, Foxrock, Dublin (IE); John Chambers, Newton, Rathcoole, County Dublin (IE)

(21) Appl. No.: 17/425,671

(22) PCT Filed: Jan. 24, 2019
(86) PCT No.: PCT/EP2019/051785

§ 371 Date: Jul. 23, 2021

(51) Int. Cl. G06Q 30/06; G06Q 10/02; G06Q 30/04; G06Q 50/08

(52) U.S. Cl. CPC G06Q 30/0645; G06Q 50/08; G06Q 30/04; G06Q 10/02

(57) ABSTRACT

This invention relates to a construction equipment rental system for connecting construction equipment providers with construction equipment renters over a communication network. The construction equipment rental system comprises a server with an accessible memory having records of a plurality of items of construction equipment offered for rent by the providers, a record of at least one provider, and records of a plurality of renters thereon. The system further comprises a booking engine component configured to receive user-inputted data from a renter, access the records in memory, deliver an editable compact booking form for the required item to the renter, monitor the input of data into the compact booking form, and, in response to the input of data by the construction equipment renter, expand one or more of the collapsed sections for receipt of further user-inputted data. In this way, less data in a more compact, manageable user interface may be provided.

### TECHNICAL FIELD

This invention relates to a system and method for the rental of construction equipment. More specifically, the present invention relates to a system and method for the rental of construction equipment that has a large array of additional options associated therewith.

### BACKGROUND ART

It is accepted practice in the construction industry to rent plant and other specialist machinery when the equipment is needed, rather than incur the substantial capital expenditure purchasing a piece of equipment that may only be used sparingly by the construction professional. Due to the highly specialised nature of some equipment, heretofore, it has been common practice for the construction equipment providers to employ staff dedicated to receiving calls from customers wishing to rent the equipment. In this way, the employee can discuss the customer's requirements, can go through all the options available with the customer, and can process the order on their behalf. Although effective, there are problems with the known method.

First of all, the construction equipment provider must hire and train staff to field queries from potential and actual customers. This can be expensive and a burden on the resources of the construction equipment provider. Secondly, the process can be quite time consuming which is disadvantageous for both the customer and the provider. Thirdly, the customers will usually only be able to contact the construction equipment provider's staff during working hours and this is not always convenient or possible for them to do. This results in lost orders for the construction equipment provider. The construction equipment provider can mitigate against this risk by providing an out-of-hours service however this further increases the cost of providing the service.

Some construction equipment providers, recognising the problems with the existing methodologies have made efforts to move with the times and provide a more substantial on-line presence for their customers. For example, there are a number of websites in operation that provide construction equipment rental services such as www.hss.com, www.tenderd.com and www.equiopmentshare.com. All of these offer an online presence whereby customers can order construction equipment out of hours at a time and place of their choosing. This also obviates the need for the construction equipment providers to employ large numbers of call centre staff to field customer queries. Although useful and a step in the right direction, it is believed that none of the known offerings fully satisfies the needs of construction equipment providers and in particular construction equipment providers that rent construction equipment that has a large array of additional options associated therewith, such as, for example, mobile cranes.

The rental of such equipment, and mobile cranes in particular, is notoriously specialised and due to the complexity and breadth of options available to the customer, has not lent itself to more automated booking methodologies. This is due in part to the fact that there are so many options, an online booking form would be excessively lengthy, detailed and daunting for many users to complete. As a consequence, construction equipment providers in this area have by and large been unable to successfully integrate new technologies in their booking methodologies and typically incur higher costs, lower efficiencies and lower customer satisfaction in their booking methodologies. Customers also lack convenience in their ability to rent the equipment at a time convenient for them.

It is an object of the present invention to provide a construction equipment rental system and method that overcome at least some of the above-identified problems and that offer a useful choice to the consumer.

### SUMMARY OF INVENTION

According to the invention there is provided a construction equipment rental system for connecting construction equipment providers with construction equipment renters, the construction equipment rental system comprising:
a server with an accessible memory having records of a plurality of items of construction equipment offered for rent by the construction equipment providers,
a record of at least one construction equipment provider, and records of a plurality of construction equipment renters thereon;
the records of the plurality of items of construction equipment offered for rent by the construction equipment providers including at least: (i) a construction equipment category; (ii) a construction equipment specification; (iii) a construction equipment rental agreement; (iv) a construction equipment rental pricing schedule; and (v) a construction equipment rental availability schedule;
the system further comprising a first user interface for rendering on a remote computing device of a construction equipment renter, the first user interface permitting access to the server to the construction equipment renters, the first user interface being operable to receive input from construction equipment renters and being operable to deliver output to the construction equipment renters;
the system further comprising a second user interface for rendering on a remote computing device of a construction equipment provider, the second user interface permitting access to the server to the construction equipment provider, the second user interface being operable to receive input from construction equipment providers and being operable to deliver output to the construction equipment providers; and
in which the system comprises a booking engine component configured to: (i) receive user-inputted data from a construction equipment renter regarding the item of construction equipment that they wish to rent; (ii) access the records of the plurality of items of construction equipment offered for rent; (iii) retrieve the record of the required item of construction equipment offered for rent; (iv) deliver an editable compact booking form for the required item of construction equipment to the first user interface for completion by the construction equipment renter, the compact booking form having a plurality of sections including a plurality of collapsed sections; (v) monitor the input of data into the compact booking form by the construction equipment renter; and, in response to the input of data by the construction equipment renter, expanding one or more of the collapsed sections for receipt of further user-inputted data; (vi) access the records of the plurality of items of construction equipment offered for rent, the record of the construction equipment provider and the record of the construction equipment renter to determine a price of rental and to populate the construction equipment rental agreement; (vii) deliver the price of rental and the populated construction equipment rental agreement to the construction equipment renter; (viii) receive an executed construction equipment rental agreement from the construction equipment renter; and (ix) update the construction equipment rental availability schedule.

By having such a system, the booking form for the equipment is provided to the customer in a compact form. This has many advantages. First of all, the amount of data that will have to be transmitted to the user device, which may be a small form factor device such as a mobile telephone, will be reduced thereby saving considerably on the bandwidth requirement. Secondly, the processing requirement to render the form will also be significantly reduced. Thirdly, the user interface with the compact form will be less daunting for the customer to navigate and complete, thereby improving customer satisfaction with the booking methodology and allowing the equipment providers to utilise more efficient systems and practices. Fourth, only those options that are specified by the customer and that require further input from the customer are expanded, thereby providing a user interface that is faster and easier to navigate than was heretofore deemed possible.

In one embodiment of the invention there is provided a construction equipment rental system in which the editable compact booking form sections are arranged in a tree structure having a plurality of branches and a plurality of sub-branches, the sub-branches being collapsed and expandable only in response to a given user input. This is seen as a particularly useful and intuitive layout of the compact booking form sections that will be simple and intuitive to navigate, as well as easier to modify if needed.

In one embodiment of the invention there is provided a construction equipment rental system in which the construction equipment rental pricing schedule is a tiered schedule offering a plurality of alternative pricing structure layers based on at least one of (i) a construction equipment renter profile retrieved from the construction equipment renter record; and (ii) a construction equipment rental job specification.

This is seen as a particularly useful aspect of the present invention and tackles an area of substantial complexity in the field of construction equipment rental for equipment with a plethora of optional extras. A challenging aspect of this field is the manner in which customers are charged for the rental of the goods and services. It is important for both supplier and customer that the charges are transparent to avoid any loss of goodwill. It is further important that the correct charge is applied to avoid loss to either the provider or the customer.

Interpersonal relationships are important, and it is common for construction equipment providers to apply preferential rates for certain long-standing and/or high-spending customers, or discounted rates to attract new customers. It is also common for providers to provide different discounts to the same customer on different jobs. For example, a customer may have two sites, one large site located 5 km from the construction equipment provider's depot and another, smaller site, located 20 km away from the construction equipment provider's depot. The construction equipment provider may be in a position to provide a 10% discount for rental of equipment to the customer's larger site due to the fact that it is convenient to transport machinery so close to their depot, normal commute times will be reduced resulting in the equipment being away from the depot for a shorter period of time and available for other work. Furthermore, the provider may be willing to provide a larger discount in the hope that it will generate more work from the customer for this site. The same provider may only be able or willing to offer a 5% discount for work at the smaller site located further away. Other discounts may then be applied such as a long-standing customer discount, a special limited time offer rate, a weekend rate and so on and these discounts may be individually or cumulatively applied. By having a rental pricing schedule as a tiered schedule offering a plurality of alternative pricing structure layers, such flexibility is possible.

In one embodiment of the invention there is provided a construction equipment rental system in which the booking engine component comprises a rules engine component to determine the price of rental based at least in part on the construction equipment rental job specification including at least one of (i) the location of construction equipment rental; and (ii) the duration of construction equipment rental. Again, this provides a useful way for the construction equipment provider to apply the appropriate, most advantageous discount to the customer with a minimum of difficulty.

In one embodiment of the invention there is provided a construction equipment rental system in which the construction equipment provider has access to the records of the plurality of items of construction equipment offered for rent by that construction equipment provider including the construction equipment rental pricing schedule; and means to edit the tiered layers of the construction equipment rental pricing schedule including means to edit one or more rules of the rules engine component. In this way, it will be relatively straightforward for construction equipment providers to promote special offers and discounts as well as ensure that their current pricing is in line with market norms.

In one embodiment of the invention there is provided a construction equipment rental system in which the records of a plurality of items of construction equipment offered for rent by the construction equipment providers comprise a dedicated template for each type of item of construction equipment offered for rent. This is seen as a useful aspect of the system according to the invention. By having a template for each type of item of construction, it will be possible to apply changes to all items of equipment simultaneously rather than having to change each individual record one by one. Secondly, it will provide a uniform structure that will be easier to populate and simpler for a customer to evaluate similar offerings.

In one embodiment of the invention there is provided a construction equipment rental system in which each of the construction equipment providers has a bespoke dedicated template for the item of construction equipment offered for rent by the construction equipment provider. This is also seen as a useful aspect of the invention. A provider may have a template for all of their goods of a certain type. However, as they may offer different equipment as standard or as extras, they may require a different bespoke template for their items from those same items of their competitors. Furthermore, this will allow for a certain degree of individualization of the providers items that will help to differentiate their offerings from those of their competitors.

In one embodiment of the invention there is provided a construction equipment rental system in which the construction equipment comprises cranes. More specifically, the construction equipment may comprise mobile cranes.

In one embodiment of the invention there is provided a method of renting out construction equipment in a construction equipment rental system comprising: a server with an accessible memory having records of a plurality of items of construction equipment offered for rent by a construction equipment provider, a record of at least one construction equipment provider, and records of a plurality of construction equipment renters thereon; the method comprising the steps of:
(i) receiving user-inputted data from a construction equipment renter regarding the item of construction equipment that they wish to rent;
(ii) accessing the records of the plurality of items of construction equipment offered for rent;
(iii) retrieving the record of the required item of construction equipment offered for rent;
(iv) delivering an editable compact booking form for the required item of construction equipment to a first user interface of a remote user computing device of the construction equipment renter for completion by the construction equipment renter, the compact booking form having a plurality of sections including a plurality of collapsed sections;
(v) monitoring the input of data into the compact booking form by the construction equipment renter; and, in response to the input of data by the construction equipment renter, expanding one or more of the collapsed sections for receipt of further user-inputted data;
(vi) accessing the records of the plurality of items of construction equipment offered for rent, the record of the construction equipment provider and the record of the construction equipment renter to determine a price of rental and to populate a construction equipment rental agreement;
(vii) delivering the price of rental and the populated construction equipment rental agreement to the construction equipment renter;
(viii) receiving an executed construction equipment rental agreement from the construction equipment renter; and
(ix) updating a construction equipment rental availability schedule.

This is seen as a particularly efficient method for renting out construction equipment. The customer will not be put off by a dauntingly large form that they must fill out as only information that needs to be displayed will be displayed on their user interface and only information that needs to be retrieved will be retrieved. In this way, in addition to providing a more streamlined user interface that is easier to navigate, excessive amounts of data are not transmitted, saving bandwidth and processing requirement.

In one embodiment of the invention there is provided a method of renting out construction equipment in which the step of delivering the editable compact booking form further comprises delivering a construction equipment rental availability schedule to a first user interface of a remote user computing device of the construction equipment renter.

In one embodiment of the invention there is provided a method of renting out construction equipment in which the editable compact booking form sections are arranged in a tree structure having a plurality of branches and a plurality of sub-branches, the sub-branches being collapsed and expandable only in response to a given user input. This is seen as a particularly simple way of structuring the data for the user that will be compact and intuitive to navigate.

In one embodiment of the invention there is provided a method of renting out construction equipment in which there is provided a construction equipment rental pricing schedule arranged in a tiered format having a plurality of alternative pricing structure layers, the method comprising the step of choosing an appropriate pricing structure layer and offering a price based on at least one of (i) a construction equipment renter profile retrieved from the construction equipment renter record; and (ii) a construction equipment rental job specification.

In this way, it will be possible for construction equipment providers to apply preferential rates and discounts to loyal customers as well as offer different rates to other customers based on whether or not the provider wishes to aggressively target the work.

In one embodiment of the invention there is provided a method of renting out construction equipment including the step of determining the price of rental based at least in part on the construction equipment rental job specification including at least one of (i) the location of construction equipment rental; and (ii) the duration of construction equipment rental.

In one embodiment of the invention there is provided a method of renting out construction equipment in which the method comprises the steps of the construction equipment provider accessing the records of the plurality of items of construction equipment offered for rent by that construction equipment provider including the construction equipment rental pricing schedule; and thereafter editing the tiered layers of the construction equipment rental pricing schedule.

In one embodiment of the invention there is provided a method of renting out construction equipment comprising the initial step of a construction equipment provider creating a record of an item of construction equipment available to rent by populating a dedicated template particular to the type of item of construction equipment to be offered for rent.

In one embodiment of the invention there is provided a method of renting out construction equipment in which the method comprises the construction equipment provider populating a bespoke dedicated template for the item of construction equipment offered for rent by the construction equipment provider.

In one embodiment of the invention there is provided a computer readable medium having program code instructions stored thereon for causing a computing device to execute one or more of the steps of claims 9 to 16 inclusive.

### BRIEF DESCRIPTION OF THE DRAWINGS

The invention will now be more clearly understood from the following description of some embodiments thereof given by way of example only with reference to the accompanying drawings, in which:—

FIG. 1 is a diagrammatic representation of a system according to the invention;

FIGS. 2(a) to 2(c) are screenshots of a user interface of a construction equipment renter's computing device;

FIGS. 3(a) to 3(e) are screenshots of a user interface of a construction equipment renter's computing device; and

FIGS. 4(a) to 4(d) are screenshots of a user interface of a construction equipment renter's computing device.

### DETAILED DESCRIPTION OF THE DRAWINGS

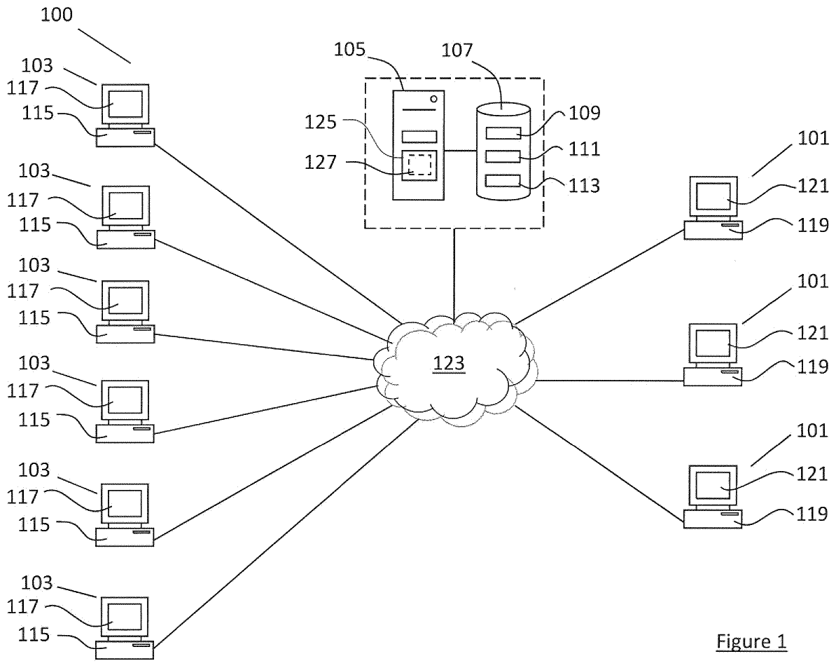

Referring to FIG. 1, there is shown a construction equipment rental system, indicated generally by the reference numeral 100 for connecting construction equipment providers 101 with construction equipment renters 103. The system comprises a server 105 having an accessible memory 107. The accessible memory comprises a plurality of records 109 of items of construction equipment offered for rent by construction equipment providers, a plurality of records 111 of construction equipment providers and a plurality of records 113 of construction equipment renters.

The plurality of construction equipment renters 103 each have a computing device 115 having a first user interface 117. The plurality of construction equipment providers 101 also each have a computing device 119 with a second user interface 121. The construction equipment providers 101 and the construction equipment renters 103 access the server 105 via a communication link though a communication network, in this case the internet 123.

The records 109 of the plurality of items of construction equipment offered for rent by the construction equipment providers include at least: (i) a construction equipment category; (ii) a construction equipment specification; (iii) a construction equipment rental agreement; (iv) a construction equipment rental pricing schedule; and (v) a construction equipment rental availability schedule. The plurality of records 111 of construction equipment providers may include one or more of: identification data; permissions data for those parties able to amend records relating to the construction equipment provider such as the equipment made available to rent; payment account details; contact details and the like. The plurality of records 113 of construction equipment renters may include one or more of: identification data; contact details; payment information and the like. If a construction equipment renter is not registered with the system they may be allocated visitor status and provided access as a visitor.

The server 105 includes a booking engine component 125 which in turn comprises a rules engine component 127. The booking engine component 125 is configured to: (i) receive user-inputted data from a construction equipment renter regarding the item of construction equipment that they wish to rent; (ii) access the records of the plurality of items of construction equipment offered for rent; (iii) retrieve the record of the required item of construction equipment offered for rent; (iv) deliver an editable compact booking form for the required item of construction equipment to the first user interface for completion by the construction equipment renter, the compact booking form having a plurality of sections including a plurality of collapsed sections; (v) monitor the input of data into the compact booking form by the construction equipment renter; and, in response to the input of data by the construction equipment renter, expanding one or more of the collapsed sections for receipt of further user-inputted data; (vi) access the records of the plurality of items of construction equipment offered for rent, the record of the construction equipment provider and the record of the construction equipment renter to determine a price of rental and to populate the construction equipment rental agreement; (vii) deliver the price of rental and the populated construction equipment rental agreement to the construction equipment renter; (viii) receive an executed construction equipment rental agreement from the construction equipment renter; and (ix) update the construction equipment rental availability schedule. The rules engine component 127 is configured to determine the price of rental based at least in part on the construction equipment rental job specification including at least one of (i) the location of construction equipment rental; and (ii) the duration of construction equipment rental.

In use, a construction equipment provider accesses a template for rental of a piece of equipment, for example, a mobile crane (not shown). The template may be a generic template for a mobile crane across all providers although more likely, the template will be a generic template for that provider's mobile cranes (assuming that they have multiple mobile cranes available to rent) and at the same time the template will be bespoke for that construction equipment provider. In this way, the provider can provide the information on their cranes which they believe is relevant to the consumer and display it in a manner that they believe is most advantageous for attracting customers accessing the site. The construction equipment provider populates the template with the information about the piece of construction equipment including the equipment category (e.g. mobile crane), the equipment specification (e.g. lifting capacity, all terrain, reach capability etc), the equipment pricing schedule (hourly, daily, weekly rates, weekend rates, discounts for new or existing customers etc) and the equipment rental agreement (outlining their terms and conditions, warranties, indemnities and the like) and saves that template as a record 109 of construction equipment in accessible memory 107. The record 109 will also include a rental availability schedule that may be populated as the equipment is booked for rent by customers. The construction equipment provider 101 will also populate a record 111 of the construction equipment provider 111 in memory 107.

The construction equipment renter 103 may be a registered user of the system or may be a visitor to the system. If a registered user, the construction equipment renter, using their computing device 115 and user interface 117, will register with the system 100 by creating a profile for themselves and save the profile as one of the plurality of records 113 of construction equipment renters in accessible memory 107. If the construction equipment renter is operating as a visitor, a temporary record 113 of the construction equipment renter may be created and saved in accessible memory. The record 113 of the construction equipment renter may have information such as billing address, contact details, payment information, past rental history, a customer rating (e.g. they could be considered a silver, gold or platinum customer based on the expenditure through the system and their classification could entitle them to certain privileges, such as preferential payment terms or credit, or discounts on the payment structure.

The construction equipment provider 101 can provide a rental pricing schedule that is a tiered schedule offering a plurality of alternative pricing structure layers based on at least one of (i) a construction equipment renter profile retrieved from the construction equipment renter record; and (ii) a construction equipment rental job specification. In other words, the construction equipment provider 101 can apply discount rates based on the construction equipment renter profile. For example, if the construction equipment renter profile indicates that the customer is a visitor, no discount may be applied. If on the other hand, the construction equipment renter profile indicates that the customer is a long standing and/or a high turnover generating customer, one or more discount levels may be applied. Furthermore, depending on the construction equipment rental job specification, additional discounts or rate structures may be applied. For example, if the job requires a short commute, a large discount may be applied or if the job is on a site that has already generated a lot of revenue for the construction equipment provider, a greater (or lesser) discount may be applied. These factors can be taken into consideration providing a very flexible invoicing structure in a relatively simple and straightforward manner. The rules engine component 127 can determine whether discounts or different rates are to be applied based on, for example, the duration of rental, the dates of rental (e.g. a three day weekend rate may be preferential over a three day rate) and/or the location of rental (e.g. in a particular jurisdiction, whether tolls are payable en route to and from the site, whether a distance exceeding a certain threshold will have to be travelled to reach the site).

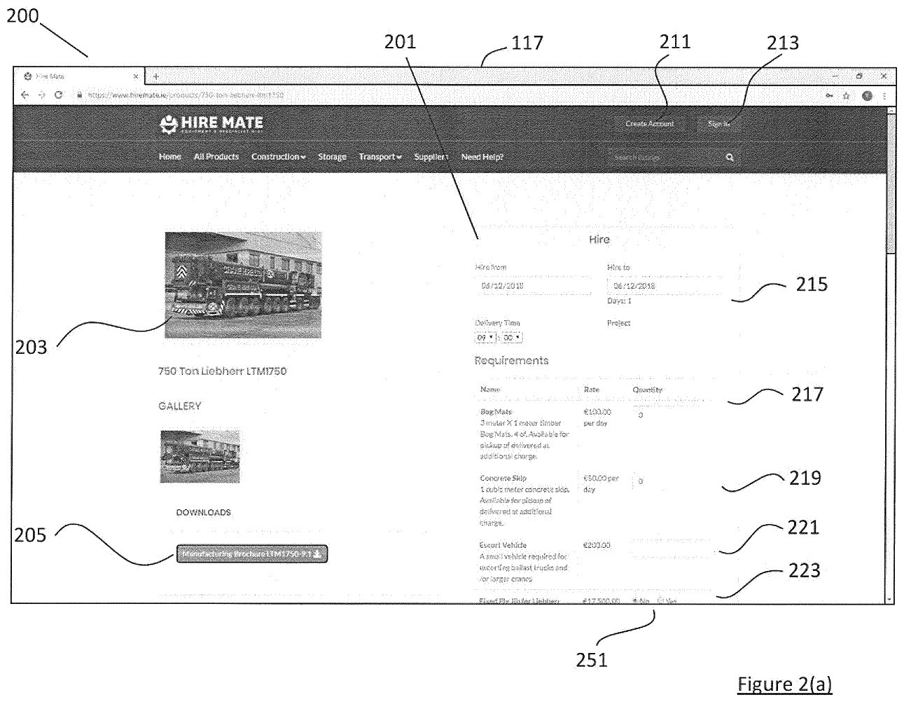

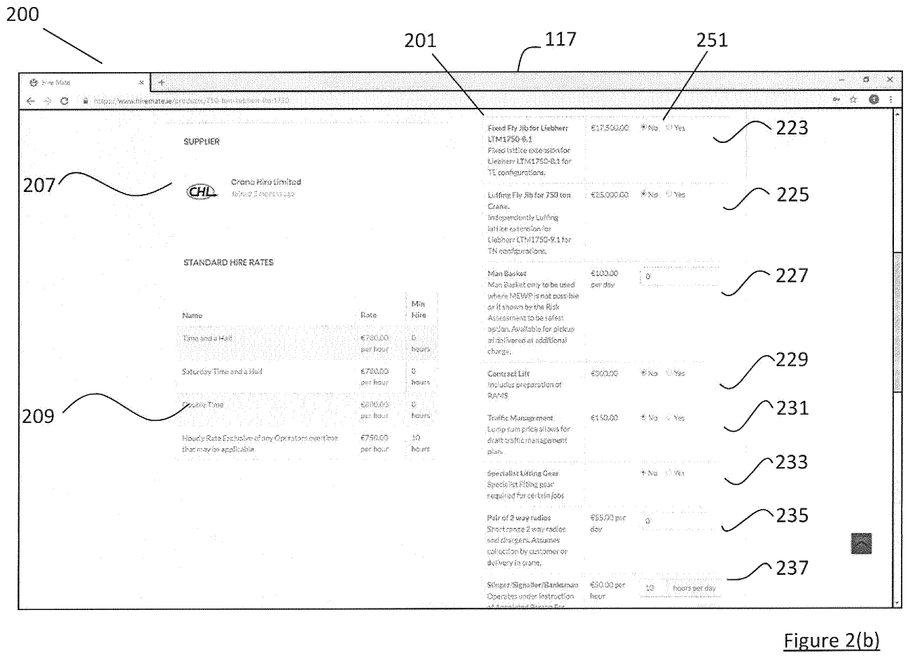

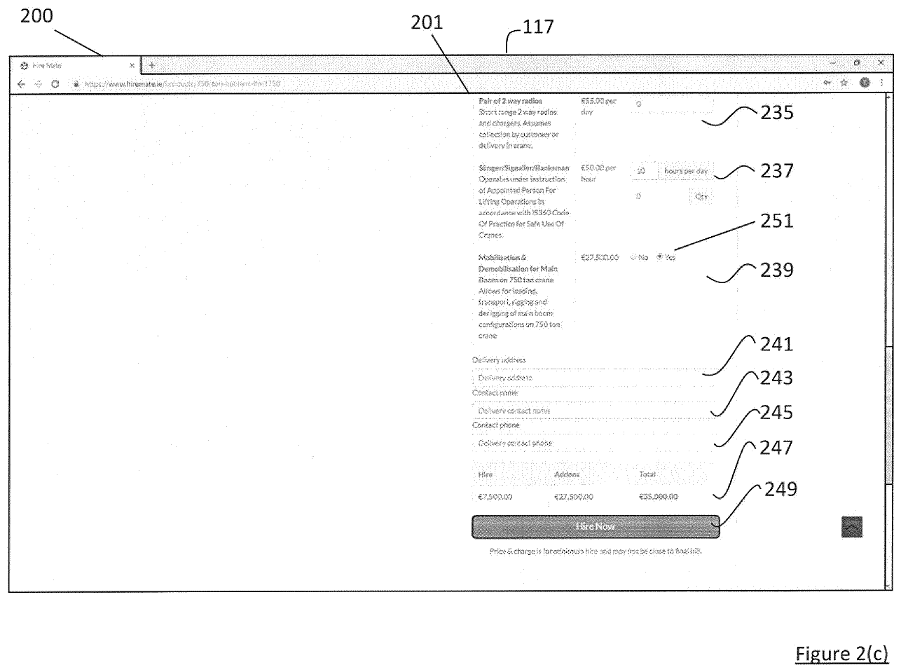

Referring now to FIGS. 2(a) to 4(d) inclusive, there are shown a plurality of screenshots of a user interface (e.g. a web page) of certain stages of the rental booking process. Referring initially to FIGS. 2(a) to 2(c), there are shown screenshots, indicated generally by the reference numeral 200, of a construction equipment renters user interface 117 on which there is rendered an editable compact booking form 201 for a piece of construction equipment. In this case, the piece of construction equipment is a 750 Ton Liebherr LTM1750 mobile crane. Again, this item of construction equipment has been provided for the purposes of the present example only and is not necessarily deemed limiting unless otherwise specified in the claims.

It can be seen that the editable compact booking form extends over a plurality of screenshots 2(a) to 2(c) even in compact format. For the sake of clarity, a degree of overlap between adjacent screenshots has been provided (for example, certain components of the editable compact booking form 201 at the bottom of the screenshot in FIG. 2(a) are shown at the top of the editable compact booking form 201 screen shot of FIG. 2(b), and certain components of the editable compact booking form 201 at the bottom of the screenshot in FIG. 2(b) are shown at the top of the editable compact booking form 201 screen shot of FIG. 2(c)).

The construction equipment renter will have browsed a catalogue (not shown) of construction equipment items offered for rent or will have entered an appropriate search term in a search engine as would be commonly known in the art and will have selected from an available list of mobile cranes the 750 Ton Liebherr LTM1750. A record 109 of the item of construction equipment (the 750 Ton Liebherr LTM1750) offered for rent by construction equipment providers is retrieved from accessible memory 107 and the server creates an editable compact booking form 201 and delivers the editable compact booking form 201 to the construction equipment renter's computing device 115. The editable compact booking form, in this example, includes pictures 203 and specification data 205, in this case a manufacturing brochure, relating to the construction equipment for rent. Identification information and branding 207 of the construction equipment provider 101 and standard rate information 209 is included in the form (see FIG. 2(b)).

Referring again to FIG. 2(a), the construction equipment renter 103 has the option of creating an account on the system by clicking on the “create account” button 211 in the known manner or logging in to the system by clicking on the “sign in” button 213. This may enable them to avail of preferential rates or offers for registered users.

The editable compact form includes a plurality of sections including a hiring period section 215 which in turn comprises a date box to indicate when the equipment will be hired from and until when the equipment will be hired and a time box which will indicate when the equipment will be collected. Thereafter, the editable compact form includes a number of optional extras and in some cases the unit cost of those extras including “Bog Mats” 217, Concrete Skip 219, Escort Vehicle 221, Fixed Fly Jib 223, Luffing Fly Jib 225, Man Basket 227, Contract Lift 229, Traffic Management 231, Specialist Lifting Gear 233, Two Way Radios 235, Slinger/Signaller/Banksman 237 and Mobilisation/Demobilisation for main boom 239. A delivery address field 241 is provided to allow the construction equipment renter specify where the construction equipment is to be delivered, as well as a contact name field 243 and contact number field 245 for a point of contact in the construction equipment renters enterprise. Finally, a total cost field 247 and a “Hire Now” button 249 are provided to demonstrate the total cost of rental based on the information supplied and options selected and to allow the construction equipment renter to confirm the rental of the construction equipment.

In FIGS. 2(a) to 2(c), there are Yes/No check boxes 251 beside many of the options. In FIGS. 2(a) to 2(c), all of the checkboxes 251 are marked “No” initially with the exception of checkbox 251 beside the Mobilisation/Demobilisation for main boom 239 field. This checkbox 251 beside the Mobilisation/Demobilisation for main boom 239 field is marked “Yes”. The total cost field 247 includes the cost of the Mobilisation/Demobilisation for main boom 239 along with the base cost of rental based on the best discounted rate for that customer.

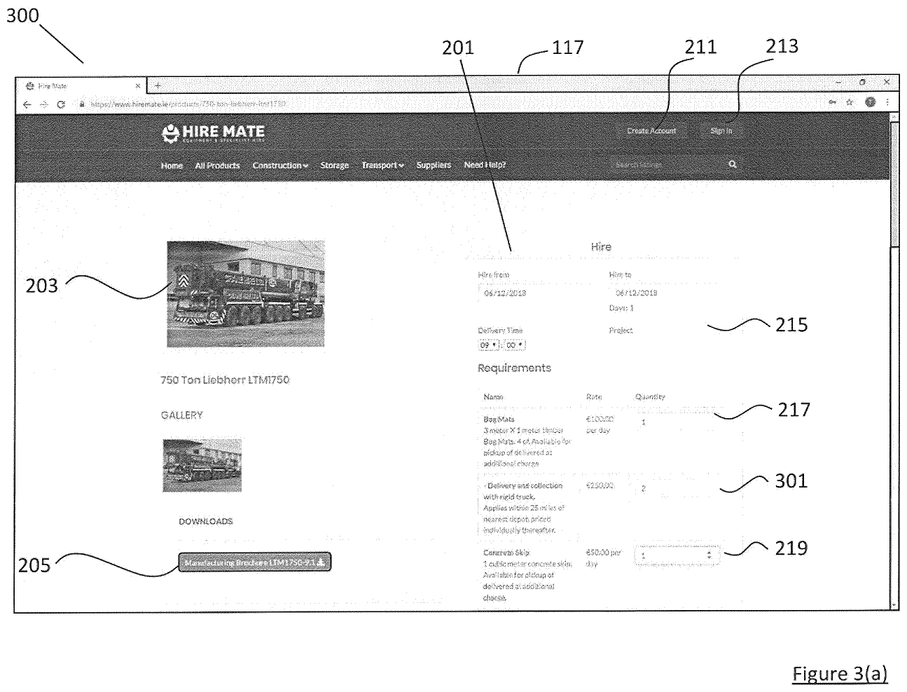

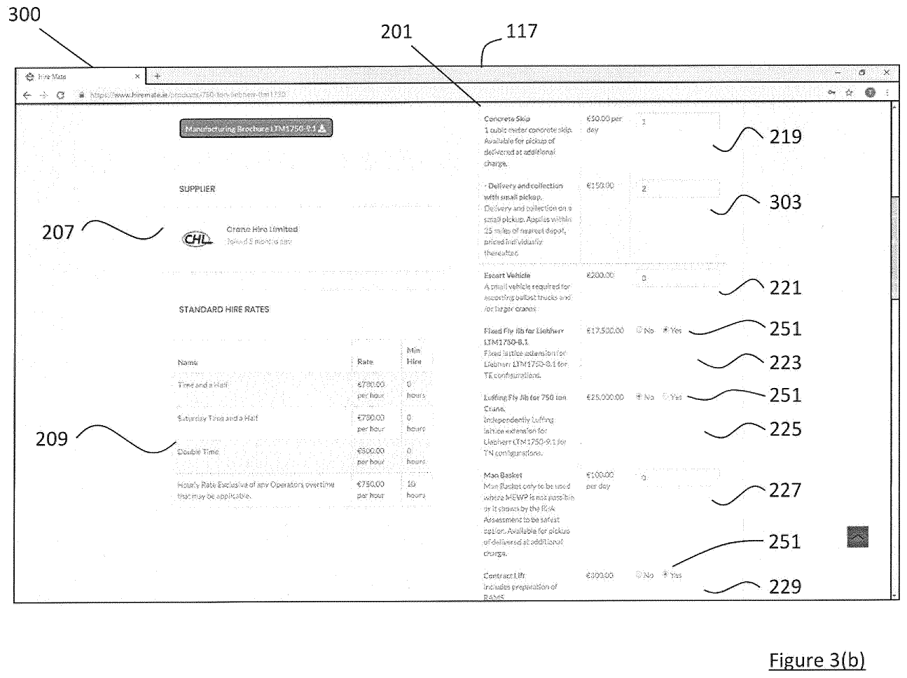

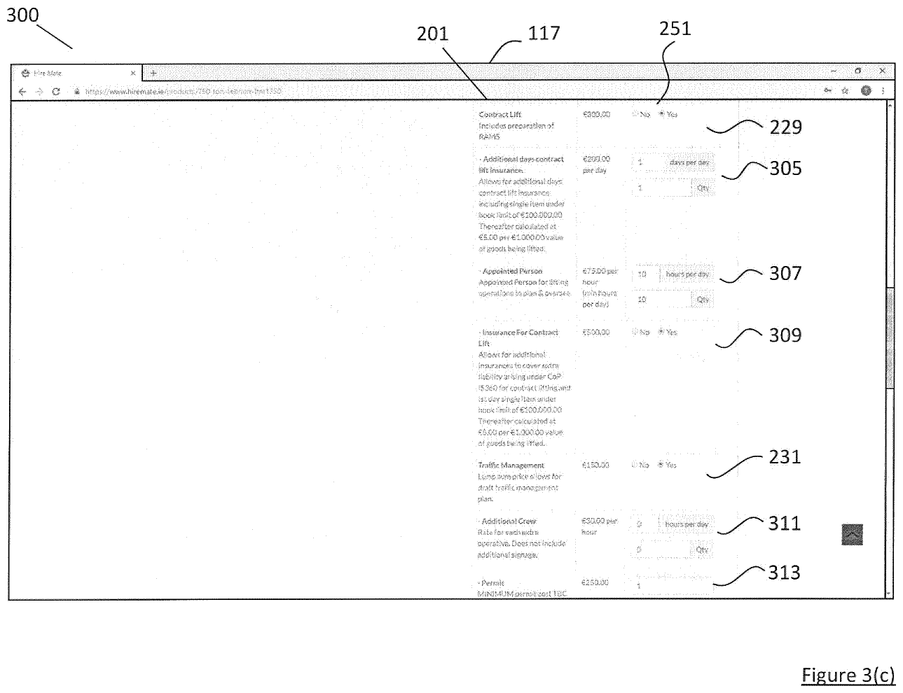

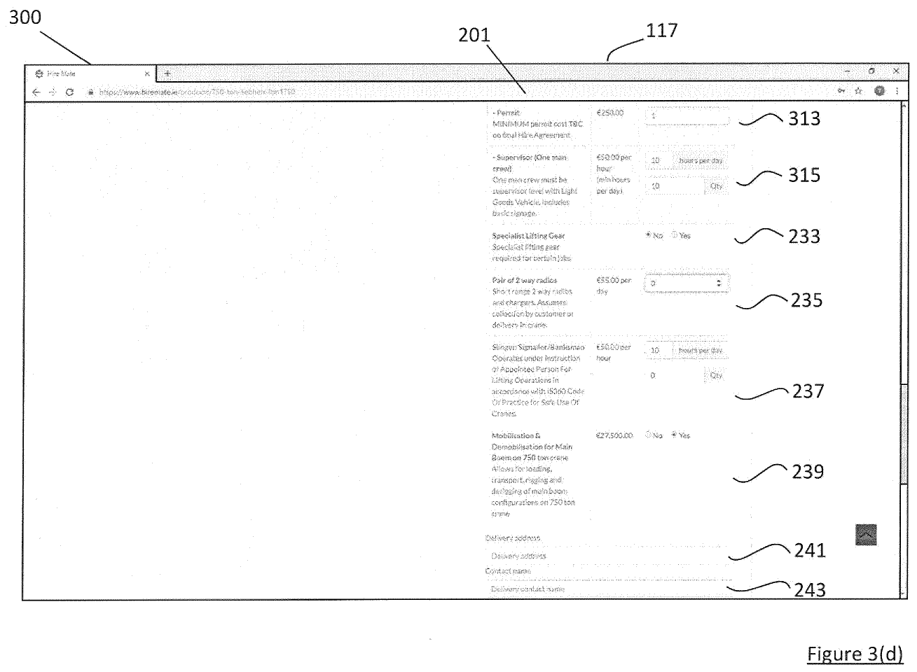

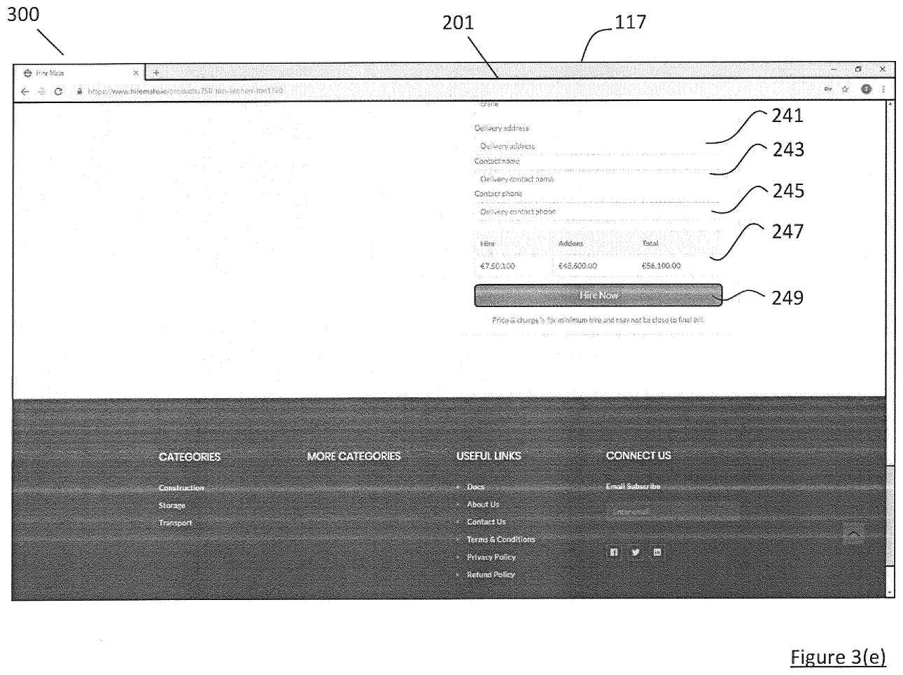

Referring now to FIGS. 3(a) to 3(e) inclusive, there are shown a number of additional screenshots, indicated generally by the reference numeral 300, of a construction equipment renters user interface 117 on which there is rendered the editable compact booking form 201 for a piece of construction equipment with some of the options checkboxes 251 having been selected and the options expanded. Like parts have been given the same reference numeral as before. Referring specifically to FIG. 3(a), it can be seen that the construction equipment renter selected a quantity of 1 bog mat. A further option, a Delivery and Collection (of the bog mat) option 301 is thereafter rendered as part of the editable form, along with a unit cost of that item and a unit quantity required (in this case 2, delivery and collection of the bog mat).

Referring now to FIG. 3(b), the Concrete Skip 219 option was populated with a “1” for one skip required and again, a Delivery and Collection (of the concrete skip) option 303 is thereafter rendered as part of the editable form, along with a unit cost of that item and a unit quantity required (again, in this case 2, delivery and collection of the concrete skip).

Referring now to FIG. 3(c), the Contract Lift 229 option has been selected by clicking “Yes” on the checkbox 251 beside the Contract Lift 229 option, and the Traffic Management 231 option has also been selected by clicking on the “Yes” option in the checkbox 251 beside the Traffic Management 231 option. A contract lift is one in which the crane hire company will accept a degree of liability for carrying out the lift. The unit cost of the contract lift will be added to the total cost. In addition, the editable compact form 201 will have a number of additional options provided and rendered on the user interface including an Additional Days Contract Lift Insurance field 305, an Appointed Person field 307, an Insurance for Contract Lift field 309 along with their associates costs once the Contract Lift 229 option has been selected. Subsequent to the Traffic Management 231 option having been selected, a new Additional Crew 311 option and Permit 313 option are populated into the editable booking form along with their associated costs and options (e.g. hours per day and quantity). In addition, once the Traffic Management Option 231 is selected, a Supervisor 315 option is provided in the editable booking form (as shown in FIG. 3(d)) along with appropriate data boxes to be filled by the construction equipment renter. It will be appreciated from the foregoing that the structure is akin to a tree structure where a branch, if selected, may lead to a sub-branch. The sub-branches may in turn themselves lead to other sub-sub-branches and so on to several levels of granularity. The total updated cost will be provided in the total cost field 247 as illustrated in FIG. 3(e). Once the construction equipment renter is satisfied with their selections and they wish to rent the equipment, they click on the “Hire Now” button 249.

In addition to the foregoing, additional fields may be provided on the forms including an “End Time” field and a “Project Select” field. The “End Time” field will allow the user to specify a specific time of day that the equipment will be needed until, allowing charging on an hourly basis, and the “Project Select” field will allow the user to specify the project that a piece of equipment is being used for and for the appropriate rates for that project to be applied to the rental cost. A common issue in the industry is that many customers and professionals hiring construction equipment in particular are unaware of the final hire cost and the impact of overtime when they confirm hire agreements. It will be understood that by implemented the system described, the total costs will be clearly outlined to the customer so that they have a thorough understanding of the total costs involved.

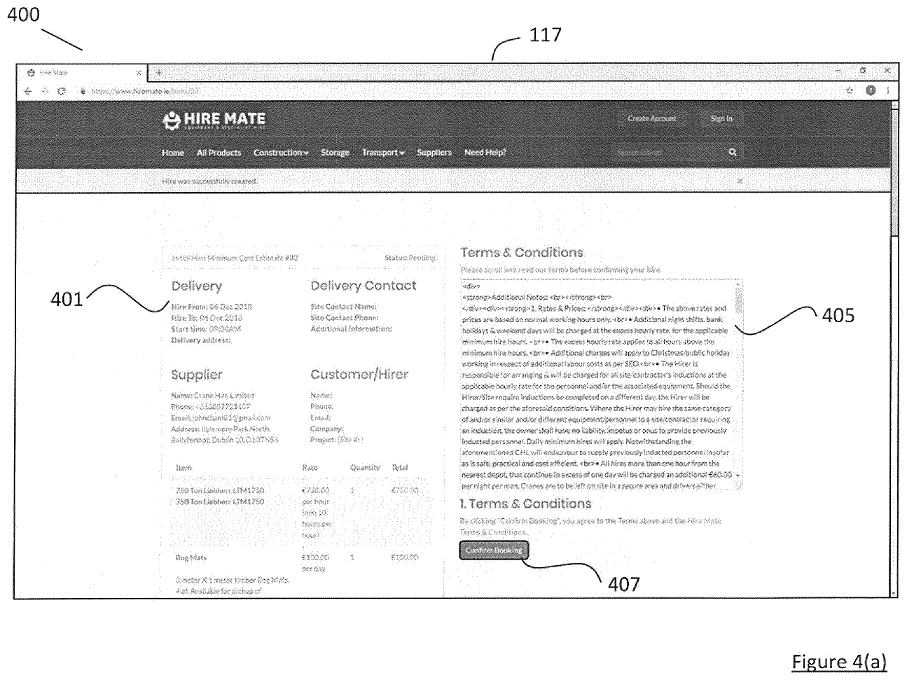

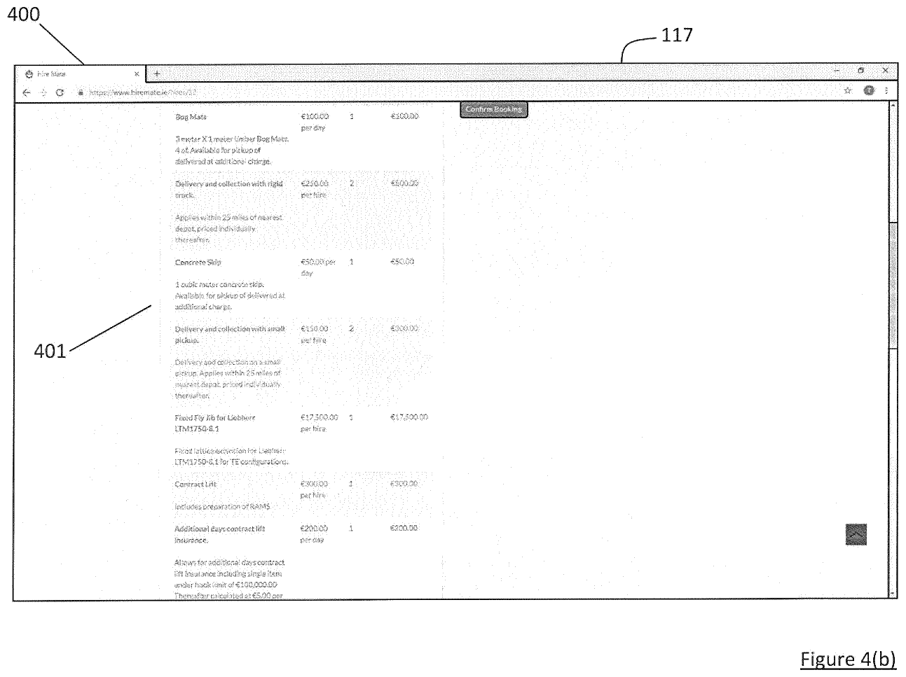

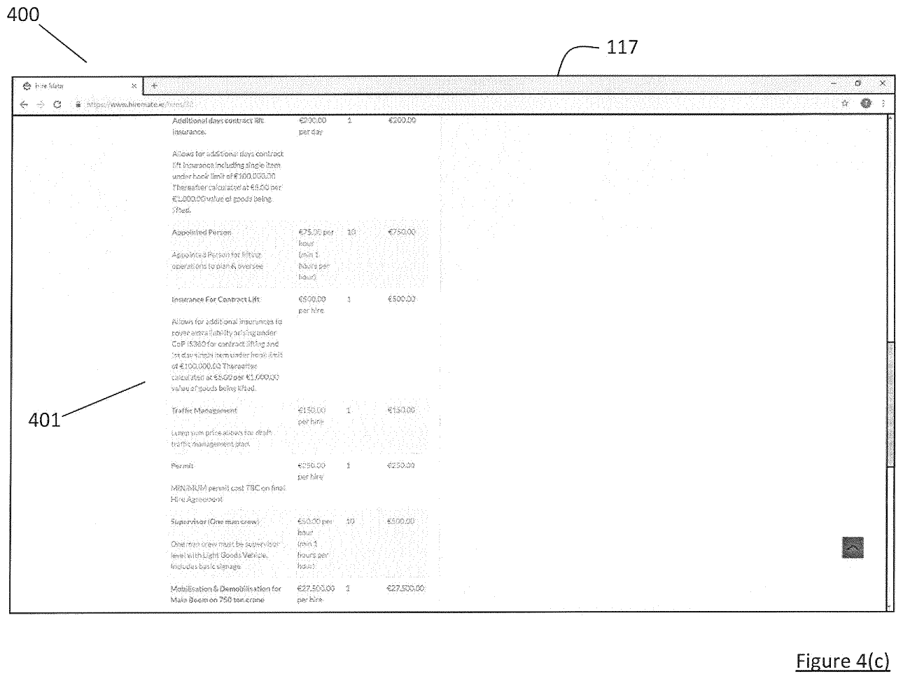

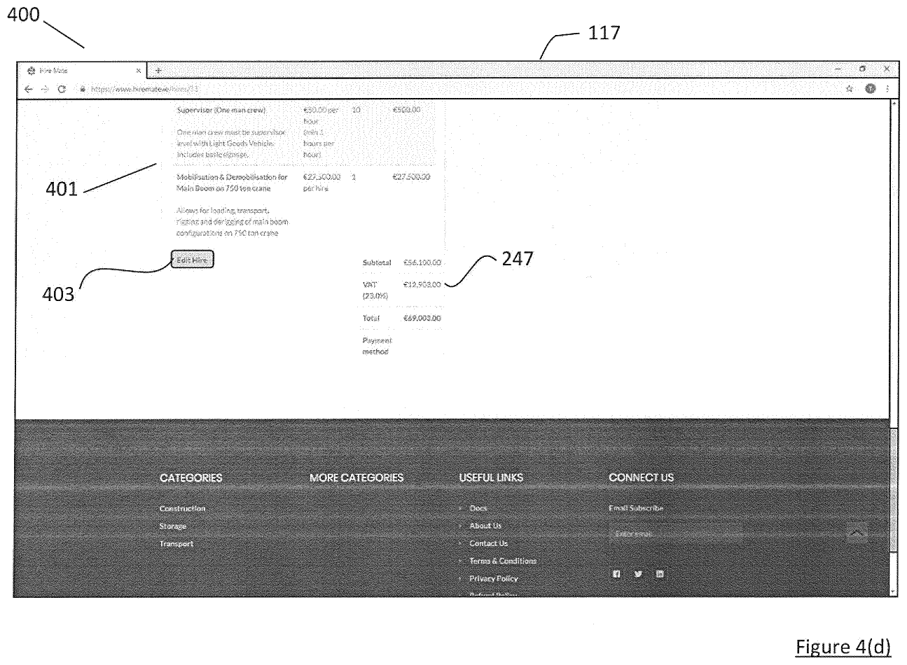

Referring now to FIGS. 4(a) to 4(d) inclusive, there are shown screenshots, indicated generally by the reference numeral 400, with the information to complete the order, where like parts have been given the same reference numeral as before. This screenshot 400 includes an order summary 401 detailing the items selected and the total cost of hire. An Edit Hire button 403 (as shown in FIG. 4(d)) is provided should the construction equipment renter choose to modify their selections in which case the user will be returned to a previous screen where they may edit their selections. The screenshot further includes a Terms and Conditions panel 405 and a “Confirm Booking” button 407 which, by clicking, the construction equipment renter agrees to the terms and conditions (this is effectively the executed rental agreement).

It will be understood that various modifications could be made without departing from the scope of the appended claims. Throughout this specification, reference has been made to the rental of a mobile crane. It will be understood that unless specified in a claim, the present invention is not limited to the rental of mobile cranes and indeed it is envisaged that other equipment would also benefit from being rented using the present invention. For example, other pieces of construction equipment or other equipment could be rented in a similar manner without departing from the scope of the appended claims.

It will be further understood that various parts of the present invention are performed in hardware and other parts of the invention may be performed either in hardware and/or software. It will be understood that the method steps and various components of the present invention will be performed largely in software and therefore the present invention extends also to computer programs, on or in a carrier, comprising program instructions for causing a computer or a processor to carry out steps of the method or provide functional components for carrying out those steps. The computer program may be in source code format, object code format or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit. In certain circumstances, a transmissible carrier such as a carrier signal when transmitted either wirelessly and/or through wire and/or cable could carry the computer program in which cases the wire and/or cable constitute the carrier.

It will be further understood that the present invention may be performed on two, three or more devices with certain parts of the invention being performed by one device and other parts of the invention being performed by another device. The devices may be connected together over a communications network. The present invention and claims are intended to also cover those instances where the system is operated across two or more devices or pieces of apparatus located in one or more locations.

It will be understood that parts of the present invention may be delivered as an online web application, hosted in the cloud on a multi-server infrastructure. The computer program code is built primarily using Ruby on Rails® Framework, PostgreSQL Database, background workers and external services for image hosting and online payments. The web interface is a responsive HTML and CSS website that provides suitable layouts to display on mobile, tablet and desktop internet enabled devices. JSON API endpoints are used for data transfer to authenticated customer and supplier software systems and Apps.

In this specification the terms “comprise, comprises, comprised and comprising” and the terms “include, includes, included and including” are all deemed totally interchangeable and should be afforded the widest possible interpretation.

The invention is not limited to the embodiments hereinbefore described but may be varied in both construction and detail within the scope of the appended claims.

1) A construction equipment rental system for connecting construction equipment providers with construction equipment renters, the construction equipment rental system comprising:
a server with an accessible memory having records of a plurality of items of construction equipment offered for rent by the construction equipment providers, a record of at least one construction equipment provider, and records of a plurality of construction equipment renters thereon;
the records of the plurality of items of construction equipment offered for rent by the construction equipment providers including at least: (i) a construction equipment category; (ii) a construction equipment specification; (iii) a construction equipment rental agreement; (iv) a construction equipment rental pricing schedule; and (v) a construction equipment rental availability schedule;
the system further comprising a first user interface for rendering on a remote computing device of a construction equipment renter, the first user interface permitting access to the server to the construction equipment renters, the first user interface being operable to receive input from construction equipment renters and being operable to deliver output to the construction equipment renters;
the system further comprising a second user interface for rendering on a remote computing device of a construction equipment provider, the second user interface permitting access to the server to the construction equipment provider, the second user interface being operable to receive input from construction equipment providers and being operable to deliver output to the construction equipment providers; and
in which the system comprises a booking engine component configured to: (i) receive user-inputted data from a construction equipment renter regarding the item of construction equipment that they wish to rent; (ii) access the records of the plurality of items of construction equipment offered for rent; (iii) retrieve the record of the required item of construction equipment offered for rent; (iv) deliver an editable compact booking form for the required item of construction equipment to the first user interface for completion by the construction equipment renter, the compact booking form having a plurality of sections including a plurality of collapsed sections; (v) monitor the input of data into the compact booking form by the construction equipment renter; and, in response to the input of data by the construction equipment renter, expanding one or more of the collapsed sections for receipt of further user-inputted data; (vi) access the records of the plurality of items of construction equipment offered for rent, the record of the construction equipment provider and the record of the construction equipment renter to determine a price of rental and to populate the construction equipment rental agreement; (vii) deliver the price of rental and the populated construction equipment rental agreement to the construction equipment renter; (vii) receive an executed construction equipment rental agreement from the construction equipment renter; and (ix) update the construction equipment rental availability schedule.

2) A construction equipment rental system as claimed in claim 1 in which the editable compact booking form sections are arranged in a tree structure having a plurality of branches and a plurality of sub-branches, the sub-branches being collapsed and expandable only in response to a given user input.

3) A construction equipment rental system as claimed in claim 1 in which the construction equipment rental pricing schedule is a tiered schedule offering a plurality of alternative pricing structure layers based on at least one of (i) a construction equipment renter profile retrieved from the construction equipment renter record; and (ii) a construction equipment rental job specification.

4) A construction equipment rental system as claimed in claim 3 in which the booking engine component comprises a rules engine component to determine the price of rental based at least in part on the construction equipment rental job specification including at least one of (i) the location of construction equipment rental; and (ii) the duration of construction equipment rental.

5) A construction equipment rental system as claimed in claim 4 in which the construction equipment provider has access to the records of the plurality of items of construction equipment offered for rent by that construction equipment provider including the construction equipment rental pricing schedule; and means to edit the tiered layers of the construction equipment rental pricing schedule including means to edit one or more rules of the rules engine component.

6) A construction equipment rental system as claimed in claim 1 in which the records of a plurality of items of construction equipment offered for rent by the construction equipment providers comprise a dedicated template for each type of item of construction equipment offered for rent.

7) A construction equipment rental system as claimed in claim 6 in which each of the construction equipment providers has a bespoke dedicated template for the item of construction equipment offered for rent by the construction equipment provider.

8) A construction equipment rental system as claimed in claim 1 in which the construction equipment comprises cranes.

9) A method of renting out construction equipment in a construction equipment rental system comprising: a server with an accessible memory having records of a plurality of items of construction equipment offered for rent by a construction equipment provider, a record of at least one construction equipment provider, and records of a plurality of construction equipment renters thereon; the method comprising the steps of:
(i) receiving user-inputted data from a construction equipment renter regarding the item of construction equipment that they wish to rent;
(ii) accessing the records of the plurality of items of construction equipment offered for rent;
(iii) retrieving the record of the required item of construction equipment offered for rent;
(iv) delivering an editable compact booking form for the required item of construction equipment to a first user interface of a remote user computing device of the construction equipment renter for completion by the construction equipment renter, the compact booking form having a plurality of sections including a plurality of collapsed sections;
(v) monitoring the input of data into the compact booking form by the construction equipment renter; and, in response to the input of data by the construction equipment renter, expanding one or more of the collapsed sections for receipt of further user-inputted data;
(vi) accessing the records of the plurality of items of construction equipment offered for rent, the record of the construction equipment provider and the record of the construction equipment renter to determine a price of rental and to populate a construction equipment rental agreement;
(vii) delivering the price of rental and the populated construction equipment rental agreement to the construction equipment renter;
(viii) receiving an executed construction equipment rental agreement from the construction equipment renter; and
(ix) updating a construction equipment rental availability schedule.

10) A method of renting out construction equipment as claimed in claim 9 in which the step of delivering the editable compact booking form further comprises delivering a construction equipment rental availability schedule to a first user interface of a remote user computing device of the construction equipment renter.

11) A method of renting out construction equipment as claimed in claim 9 in which the editable compact booking form sections are arranged in a tree structure having a plurality of branches and a plurality of sub-branches, the sub-branches being collapsed and expandable only in response to a given user input.

12) A method of renting out construction equipment as claimed in claim 9 in which there is provided a construction equipment rental pricing schedule arranged in a tiered format having a plurality of alternative pricing structure layers, the method comprising the step of choosing an appropriate pricing structure layer and offering a price based on at least one of (i) a construction equipment renter profile retrieved from the construction equipment renter record; and (ii) a construction equipment rental job specification.

13) A method of renting out construction equipment as claimed in claim 12 including the step of determining the price of rental based at least in part on the construction equipment rental job specification including at least one of (i) the location of construction equipment rental; and (ii) the duration of construction equipment rental.

14) A method of renting out construction equipment as claimed in claim 12 in which the method comprises the steps of the construction equipment provider accessing the records of the plurality of items of construction equipment offered for rent by that construction equipment provider including the construction equipment rental pricing schedule; and thereafter editing the tiered layers of the construction equipment rental pricing schedule.

15) A method of renting out construction equipment as claimed in claim 9 comprising the initial step of a construction equipment provider creating a record of an item of construction equipment available to rent by populating a dedicated template particular to the type of item of construction equipment to be offered for rent.

16) A method of renting out construction equipment as claimed in claim 15 in which the method comprises the construction equipment provider populating a bespoke dedicated template for the item of construction equipment offered for rent by the construction equipment provider.

17) A computer readable medium having program code instructions stored thereon for causing a computing device to execute one or more of the steps of claim 9 inclusive.
